(19) United States
(12) Patent Application Publication
(10) Pub. No.: US 2026/0359055 A1
(43) Pub. Date: Nov. 12, 2026

(54) MICRO INSTRUCTION SET ARCHITECTURE PACKET PROCESSOR

(71) Applicant: Dreambig Semiconductor Inc., San Jose, CA (US)

(72) Inventors: Pranab Ghosh, Pleasanton, CA (US); Faisal Masood, San Jose, CA (US); Imtiaz Ahmed, Pleasanton, CA (US); Sohail A. Syed, San Jose, CA (US)

(73) Assignee: Dreambig Semiconductor Inc., San Jose, CA (US)

(21) Appl. No.: 19/199,594

(22) Filed: May 6, 2025

(51) Int. Cl. G06F 9/38; H04L 69/22

(52) U.S. Cl. CPC G06F 9/3851; H04L 69/22

(57) ABSTRACT

A method is provided to process a network packet, the method comprising: storing a set of instructions in a non-transitory storage medium that includes one or more respective header adjustment instructions that include a header type identifier, operation code, and operand; receiving the set of instructions; receiving a header stack; and configuring the packet processor circuit with the set of instructions to adjust in parallel, headers in the header stack that are identified by a header identifier within an adjustment instruction in the set of instructions to produce a modified header stack, based on, for each such identified header, a respective opcode and a respective operand included in a respective header adjustment instruction in the set of instructions that includes the respective header identifier that identifies such identified header.

### BACKGROUND

High-performance networks generally offload network processing tasks from a host system to specialized network hardware circuits to achieve high bandwidth line rate processing and reduce processing power requirements. Network processing offload criteria generally are specified as a set of rules to match with packet fields and/or associated metadata. Actions involve modifications to be applied on matching packets, associated metadata, or both: matches and corresponding actions work together to achieve the offload. If a packet matches with a pre-defined rule, the corresponding actions are applied to the packet or associated metadata or both.

### SUMMARY

In one aspect, a method is provided to process a network packet. A first set of instructions is stored in a non-transitory storage medium that includes one or more respective header adjustment instructions that include a header type identifier, operation code, and operand. The first set of instructions is received as input to the packet header processor. A header stack is received as input to the packet header processor. The packet processor circuit is configured with the first set of instructions to perform an operation that includes adjusting, in parallel, all headers in the header stack that are identified by a header identifier within an adjustment instruction in the first set of instructions. The in-parallel adjustment of all such identified headers in the header stack produces a first modified header stack. For each such identified header, an adjustment to the header is made based upon a respective opcode and a respective operand included in a respective header adjustment instruction in the first set of instructions that includes a respective header identifier that identifies such identified header.

In another aspect, a network packet processing system is provided that includes a packet header processor circuit that includes an instruction input, a packet header arrangement input, a packet parser circuit, a micro-operations processing circuit, and a non-transitory storage medium. The packet arrangement information can indicate header types and their locations within a packet header. The parser circuit parses a set of instructions, a header stack, and packet arrangement information to associate the adjustment instructions with header types in the received header stack. The non-transitory storage medium stores multiple respective sets of executable instructions that include header adjustment instructions that include a header type identifier, operation code, and operand, each respective set of instructions, when executed by the packet header processor circuit, causes the micro-operations processing circuit to perform operations that that includes adjusting, in parallel, all headers in the header stack that are identified by a header identifier within an adjustment instruction in a respective set of instructions currently received at the instruction input. The in-parallel adjustment of all such identified headers in the header stack produces a modified header stack. For each such identified header, an adjustment to the header is made based upon a respective opcode and a respective operand included in a respective header adjustment instruction in the respective set of instructions that includes a respective header identifier that identifies such identified header.

In yet another aspect, a network packet processing system is provided that includes a non-transitory storage medium, multiple packet header processor core circuits, and routing circuitry for routing information to the respective packet header processor core circuits. The non-transitory storage medium stores multiple respective sets of instructions that are executable by the respective packet header processor core circuits, wherein respective sets of instructions include one or more respective header adjustment instructions that include a header type identifier, operation code, and operand. Each respective core circuit includes a respective instruction input, a respective packet header stack input, a respective packet header arrangement input, a respective parser circuit, and a respective micro-operations processing circuit. The respective parser circuit can parse a set of instructions, a header stack, and arrangement information to associate the adjustment instructions with header types in the received header stack. The non-transitory storage medium stores multiple respective sets of executable instructions that include header adjustment instructions that include a header type identifier, operation code, and operand, each respective set of instructions, when executed by the packet header processor circuit, causes the micro-operations processing circuit to perform operations that that includes adjusting, in parallel, all headers in a respective header stack that are identified by a header identifier within an adjustment instruction in a respective set of instructions currently received at the respective instruction input. The in-parallel adjustment of all such identified headers in the respective header stack produces a modified header stack. For each such identified header, an adjustment to the header is made based upon a respective opcode and a respective operand included in a respective header adjustment instruction in the respective set of instructions that includes a respective header identifier that identifies such identified header. The routing circuitry routes different respective header stacks to different respective core circuits, routes different respective arrangement information to different respective core circuits, and routes different respective sets of instructions to different respective core circuits.

### BRIEF DESCRIPTION OF THE DRAWINGS

Aspects of the present disclosure are best understood from the following detailed description when read with the accompanying figures. It is emphasized that various features are not drawn to scale in accordance with the standard practice. In fact, the dimensions of the different features may be arbitrarily increased or reduced for clarity of discussion. In addition, the present disclosure may repeat reference numerals and/or letters in the various examples. This repetition is for simplicity and clarity and does not in itself dictate a relationship between the various embodiments and/or configurations discussed.

FIG. 1 is an illustrative block diagram representing a network packet processing circuit in accordance with some embodiments.

FIG. 2 is an illustrative block diagram showing details of an example match logic circuit in accordance with some embodiments.

FIG. 3 is an illustrative drawing representing an example packet received as input to the network packet processing circuit of FIG. 1.

FIGS. 4A-4B are illustrative drawings representing example packet header stack arrangement information corresponding to the example packet of FIG. 3 in accordance with some embodiments.

FIG. 5 is an illustrative drawing representing an example action program in accordance with some embodiments.

FIG. 6 is an illustrative generalized block diagram showing an example computing system that offloads network packet processing in accordance with some embodiments.

FIG. 7 is an illustrative block diagram showing additional details of an example packet processor logic circuit and associated cache memory in accordance with some embodiments.

FIG. 8 is an illustrative block diagram showing details of an example packet processor core in accordance with some embodiments.

### DETAILED DESCRIPTION

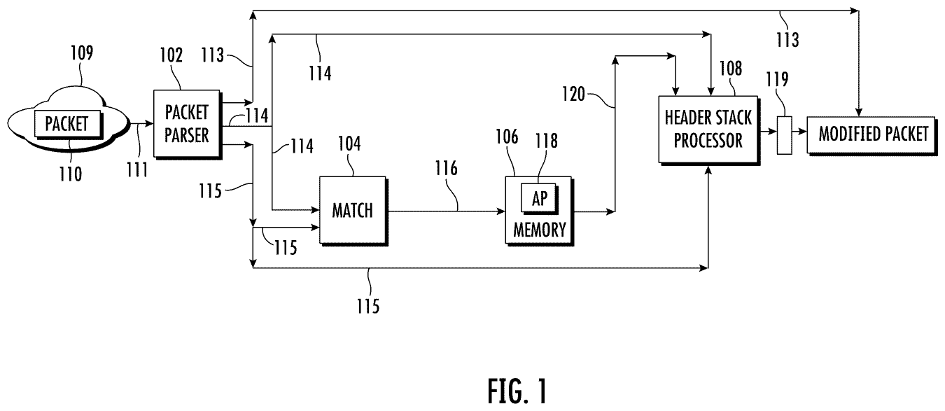

FIG. 1 is an illustrative block diagram representing a network packet processing circuit 100 in accordance with some embodiments. The network packet processing circuit 100 performs pre-defined actions on protocol headers of packets' protocol header stacks based upon pre-determined rules. The packet processing circuit includes a packet parser circuit 102, a header match logic circuit 104, a packet header processor circuit 108, and associated action program memory 106. The network packet processing circuit 100 receives a network packet 110 transmitted over a communication network 109 as input on line 111, modifies a header stack portion of the packet, and provides a modified packet 112 as output.

Packet parser 102 receives packet 110 and identifies its header stack and payload portions. Parser 102 provides a payload portion of packet 110 on line 113, a header stack portion of packet 114, and header stack arrangement information corresponding to the packet on line 115. Packet parser 102 produces the header stack arrangement information based on the content of the packet header stack portion. Example header stack arrangement information identifies packet header types contained within a packet's header stack and their locations relative to one another within the packet's header stack. Details of an example packet parser circuit 102 are provided in commonly owned co-pending U.S. patent application Ser. No. ______ (docket no.: DREAP011), Packet Parser Generating Header Stack Arrangement Information, filed on even date herewith, which is expressly incorporated herein in its entirety by this reference.

The header match logic circuit 104 is used to match the header stack portion of the received packet 110 with an action program 118 stored in memory 106 that is used to configure packet header processor circuit 108 to modify the header stack portion of the packet. An example header match logic circuit 104 provides action program-identifying information on line 116, based upon a match between the header stack and a pre-determined rule. More particularly, an example header match logic circuit 104 matches provides memory address information on line 116 that indicates an address in memory 106 of the action program.

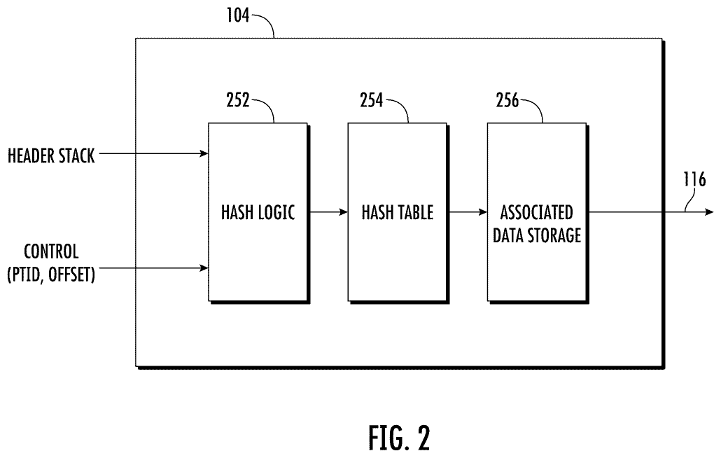

FIG. 2 is an illustrative block diagram showing details of an example match logic circuit 104 in accordance with some embodiments. The match logic circuit 104 includes hash logic 252, hash table 254, and associated data storage memory 256. The hash logic 252 generates a hash value based, at least in part, on a search key that includes at least a portion of a received packet's header stack. The search key may include portions of the header stack fields and corresponding control information. An example hash table 254 includes a ternary content addressable memory (TCAM). Different memory locations within the TCAM store different binary values that identify different memory locations within the associated data storage 256. The associated data storage 256 includes random access memory (RAM) that stores address information used to locate different action programs within memory 106. Different action programs are used to modify different header stacks based on different header stack matching rules. During a match operation, the hash logic 252 produces a hash value based at least in part upon a received packet's header stack. A binary value stored at a hash table memory location that matches the hash value is used to identify a memory location within the associated memory 256, where address information is stored that can be used to identify the location of an action program within memory 106 to be used to process the packet's header stack. The associated data storage memory 256 produces a data signal on line 116 that causes selecting an action program corresponding to the packet's header stack to configure the packet header processor 108 to process the packet's header stack. Details of example match logic 104 are provided in commonly owned U.S. Pat. No. 11,922,032, which is expressly incorporated herein in its entirety by this reference.

The packet header processor 108 outputs the modified packet header portion, and combiner logic 119 concatenates the modified header stack portion with the packet payload portion to produce the modified packet 112 as output.

FIG. 3 is an illustrative drawing representing an example packet 110 that can be received as input to the network packet processing circuit 100. The packet includes a serial sequence of ordered bit values that travel through a communication network in the direction indicated by arrow 202. The example packet includes a header stack portion 208, which can be the leading edge 204 of an example packet 110 that arrives first at the network packet processing circuit 100, and a payload portion 210, which can be the trailing edge 206 of packet 110 that arrives at the circuit 100 after the header stack portion 208. The example header stack 208 with multiple example network headers H_{A}, H_{C}, H_{D}, and H_{F} arranged in the sequence shown. The network headers H_{A}, H_{C}, H_{D}, and H_{F} arrive at network interface 118 sequentially based on their sequential arrangement within the header stack 208. The headers within packet 110 are arranged such that, H_{A} arrives first, H_{C} arrives second, H_{D} arrives third, and H_{F} arrives fourth. The payload arrives after the arrival of all the headers. The headers within the example packet 110 are arranged such that, a start of the payload 210 is offset by a first amount O1 from the start of the first header H_{F}, is offset by a second amount O2 from the start of the second header H_{D}, is offset by a third amount O3 from the start of the third header H_{C} and is offset by a fourth amount O4 from the start of the fourth header H_{A}. Offset amounts O1-O4 are indicative of the number of bits within the packet between the start of a respective header and the start of the payload. The offset amount can be measured in terms of the number of bits, bytes, or words, for example, between a header and the payload. It is noted that a packet can include other information, such as error-correcting code, which is not shown to avoid complexity unrelated to the offset relationship between headers and payload.

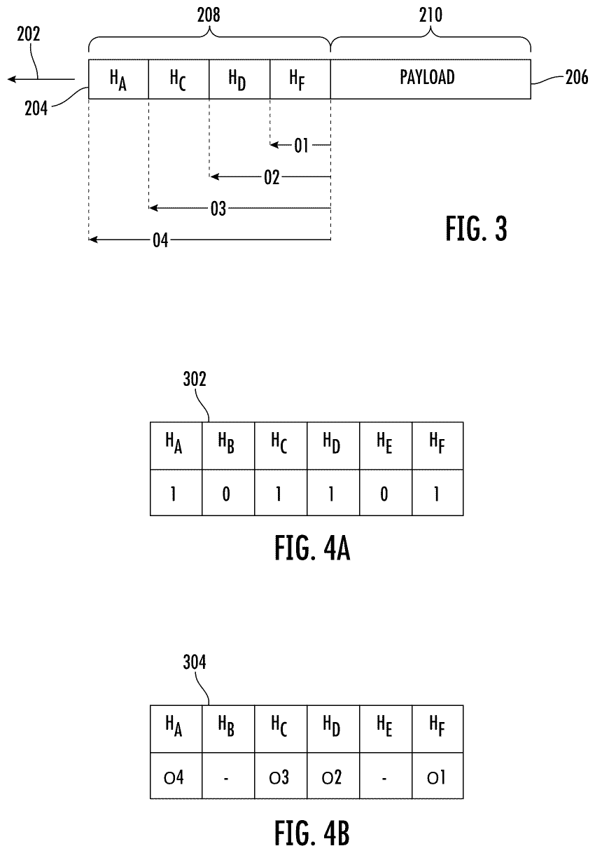

FIGS. 4A-4B are illustrative drawings representing example packet header stack arrangement information corresponding to the example packet of FIG. 3 in accordance with some embodiments. The example packet header stack arrangement information includes an example first, patent type identifier (PTID), information structure 302 (FIG. 4A) and an example second, offset information structure, 304 (FIG. 4B). Parser 102 causes one or more bits within elements of the PTID information structure 302 to be set based upon header types identified within the received packet's header stack. Packet parser 102 causes one or more offset values to be stored within elements of the offset information structure 304 based upon relative locations of the identified header types within the received packet's header stack. More specifically, the offset values stored in the offset information structure correspond to header types identified in the PTID information structure and indicate respective offsets between the payload and respective identified headers within the header stack. This illustrative example assumes six possible header types: H_{A}, H_{B}, H_{C}, H_{D}, H_{E}, and H_{F}, which can be included in a header stack. The example header stack includes only four of the six: H_{A}, H_{C}, H_{D}, and H_{F}.

More specifically, the PTID information structure 302 includes a plurality of elements, each corresponding to a different header type and each to store a binary value indicative of whether the header type to which it corresponds is present in a received packet. The offset information structure 304 also includes a plurality of elements, each corresponding to a header type in the first data structure and each to store a value indicative of an offset amount between a received packet's payload and a start of the header within the received packet to which it corresponds. Assuming that parser 102 inputs the example packet 110 of FIG. 2, which includes header types H_{A}, H_{C}, H_{D}, and H_{F}, the elements of the PTID structure 302 corresponding to packet types H_{A}, H_{C}, H_{D}, and H_{F} are set (e.g., to logic 1) and the remaining elements, H_{B} and H_{E}, are not set (e.g., logic 0). Correspondingly, the elements of the offset structure 304 corresponding to packet types H_{F}, H_{D}, H_{C}, and H_{A} have offset values O1, O2, O3, and O4, and the remaining elements, H_{B} and H_{E}, have no offset values. Since not every header type is included within a typical received packet, some elements of the second data structure are empty.

Referring to FIG. 1, packet header processor 108 executes a set of instructions contained within an action program to modify and/or shift headers within a received packet's header stack. Packet header processor 108 can use the packet header arrangement information (e.g., PTID and/or offset information) to locate header types and/or header fields within the packet's header stack that are to be modified and/or shifted. Moreover, packet header processor 108 may update the packet header arrangement information (e.g., PTID and/or offset information) based upon changes it makes to the received packet's header stack. Persons skilled in the art will understand that header types generally have predefined fields having predefined layouts and that once a header type is identified (e.g., using the PTID) and a location of the header type within a header stack is identified (e.g., using the offset information), header fields within the identified header type can be located based upon the predefined layout of fields within the header type.

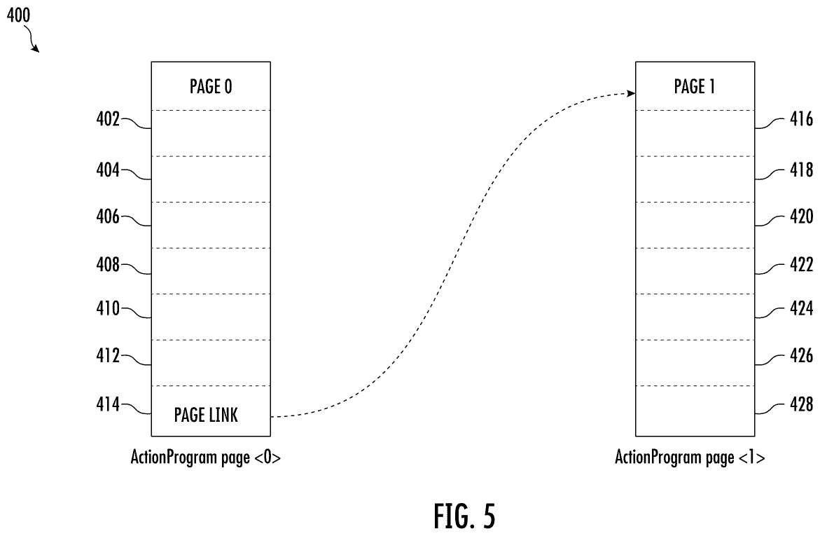

FIG. 5 is an illustrative drawing representing an example action program 400 in accordance with some embodiments. The action program includes a set of organized in memory in a page format having a fixed number of instructions that have identical fixed instruction-lengths. The sets of instructions include header adjustment instructions used to cause adjustments to information in headers in a header. The adjustment instructions have header type identifier fields, operation code fields, and operand fields with identical layouts. The action program 400 includes a set of instructions (actual instructions are not shown) in the instruction slots, indicated by the dashed lines, that are arranged into two fixed-size pages, page_0 and page_1. Each page, page_0 and page_1, of the example action program 400 contains a predetermined identical fixed number of instructions. Page_0 includes the predetermined fixed number of instructions within instruction slots 402-414, and page_1 includes the identical predetermined fixed number of instructions (not shown) within instruction slots 416-428. For simplicity of disclosure, the example pages page_0 and page_1 are shown to have only a small number of instructions. Different action programs can have different numbers of pages, but each page of each action program contains the same predetermined fixed number of instructions. Each instruction within an instruction slot 402-428 contains an identical fixed number of bits. Each instruction is stateless, i.e., it is not dependent upon other instructions. Each instruction uses one and only one instruction slot. An example match logic circuit 104 transmits memory address information on line 116 that indicates a location in memory 106 where page_0 of the action program 400 is stored. The example instruction on page_0, at slot 414, is a page_link instruction that points to an address location in memory 106 at the start of page_1 of the example program 400.

Action program instructions are fixed size, e.g. 128 Bytes. Since the action programs are stateless, they can be executed independently. They are self-contained with both operator and operands. Table 1 shows the structure of an example adjustment instruction. The format of an example adjustment instruction includes an opcode that indicates an operation to be performed by using the instruction, a header_id, that identifies a header type on which the operation is to be performed, a set of operands that are data used in the operation, and adjusted, e.g. modified and/or shifted.

TABLE 1

| | Fields | Bits | Description |
|---|---|---|---|
| 1 | opcode | 8 | Action MISA Opcode |
| 2 | header_id | 8 | header_id is typically used to indicate the |
| | | | specific header field to be modified or operated |
| | | | upon by the instruction specified by the opcode. |
| 3 | offset | 8 | Byte offset within the header referenced |
| | | | by the Header ID. |
| 4 | operand_0 | 8 | Operand 0 is used for specific instructions; |
| | | | otherwise reserved. Typically used to specify the |
| | | | length of the operation in bits |
| 5 | operand_1 | 32 | The first operand for the operation. Typically |
| | | | a bitmask for the header field or operand bits [63 |
| | | | down to 32] for a 64 bit operation. |
| 6 | operand_2 | 32 | The second operand for the operation. Typically |
| | | | operand bits [31 down to 0] for an operation. |
| 7 | operand_3 | 32 | The third operand for the operation. Typically |
| | | | used if more than 32 bits operand and bitmask |
| | | | are required. Otherwise reserved. |

Table 2 provides a list of names and descriptions of example action program instructions. Each instruction can configure the packet header processor 108 to perform a different operation on a header within a header stack.

TABLE 2

| | Instructions | Description |
|---|---|---|
| 1 | NOP | Do not perform any action. |
| 2 | WRITE_32 | Overwrite a header field with |
| | | new 32 bit value |
| 3 | WRITE_48 | Overwrite a header field with new |
| | | 48 bit value with bit mask. Useful for |
| | | Ethernet MAC operations |
| 4 | WRITE_64 | Overwrite a header field with new |
| | | 64 bit value with byte mask. |
| 5 | WRITE_CHKSUM | Overwrite a header field with new 32 |
| | | bit value and update the |
| | | header checksum |
| 6 | WRITE_META | Overwrite a 32 bit field in |
| | | Packet metadata |
| 7 | INSERT | Insert Up to 64 bits at the specified |
| | | header offset and update the packet and |
| | | header lengths. |
| 8 | REMOVE | Remove Number of Bytes from |
| | | the packet header. |
| 9 | SET_PORT | Add up to 6 ports to the |
| | | destination port list. |
| 10 | ADD | Add a 32 bit value to a header field |
| 11 | SUBTRACT | Subtract an immediate value |
| | | from a header field |
| 12 | INCR_COUNT | Increment counters to track number |
| | | of packets and number of bytes. |
| 13 | COPY_TO_META | Move a 32 bit masked value from |
| | | the header to the metadata |
| 14 | MOVE_TO_HEADER | Move 32 bit masked value from the |
| | | metadata to the packet header |
| 15 | COPY_TO_HEADER | Copy 32 bit masked value from |
| | | metadata to packet header |
| 16 | ADD_META | Add a value to a metadata field |
| 17 | SUBTRACT_META | Subtract an immediate value |
| | | from a metadata field |
| 18 | ENCAP | Insert a tunnel layer at the beginning |
| | | of the packet. |
| 19 | DECAP | Remove outer tunnel layer from |
| | | the header stack |
| 20 | PAGE_LINK | Link multiple MISA pages related |
| | | to same action program |

An example action program 118 includes a set of instructions to configure packet header processor 108 to perform one or more actions that correspond to high-level packet processing actions, which for example, can be defined by the Linux operating system and the Linux DPDK (Data Plane Development Kit). As explained more fully below, a host system 502 can be configured using a compiler program 514 to convert high-level actions defined using a higher-level computer networking program, such as an operating system level program, to action program instructions that can be used to configure the packet header processor 108 to perform the actions. As used herein, high-level actions refer to instructions in a form that must be converted to an executable form before hardware can execute them. The compiler 514 configures the host system 502 to convert high-level actions specified by using a higher-level computer networking program into an action program with a set of instructions targeted to the packet header processor 108. Table 3 sets forth illustrative examples of high-level packet processing actions and corresponding example action program instructions. An example compiler 514 is used to convert the high-level actions in the left column to the action program instructions in the right column. As explained above, the action program instructions have an identical predetermined length, i.e., the number of bits or bytes. Moreover, the compiler 514 configures the host system 502 to format the set of instructions of an action program to include one or more fixed-length action program pages, each page having a fixed identical number of instructions that each have an identical fixed length.

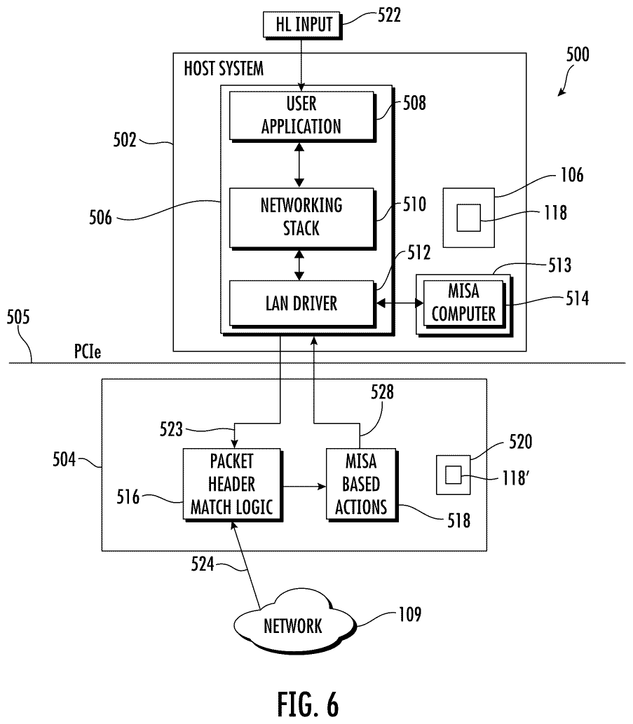

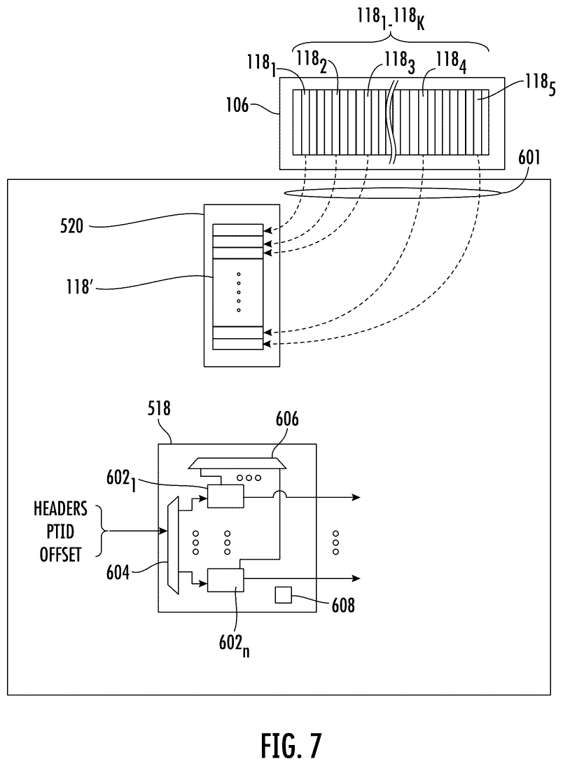

FIG. 6 is an illustrative generalized block diagram showing an example computing system 500 that offloads network packet processing in accordance with some embodiments. The computing system includes a host computing system 502 and a network packet header processing circuit 504 that communicate over a PCIe bus 505. The host computing system 502 includes a general-purpose computing machine 506 configured to run a user application 508, a networking stack 510, and a LAN driver 512. The host computing system 502 also includes memory 513 to store a compiler program 514 and includes memory 106 to store multiple action programs 118₁-118ₖ as shown in FIG. 7, which is described below. The network processing circuit 504 includes a packet header match logic circuit 516, a packet header processor logic circuit 518 (e.g., MISA based actions), and includes local cache memory 520 to store one or more of the action programs 118₁-118ₖ downloaded from the memory 106 to run on the packet processor logic circuit 518 in response to a current match determined using the header match logic circuit 516. For example, the user application 508 may run a user space application such as Web Server or File Transfer Protocol (FTP) or performance benchmarking application such as iperf. For example, the networking stack 510 can create Send and Receive queues, place Work Queue Entry (WQE) into a Send Queue. For example, the LAN driver 512 can respond to interrupts when a received packet was placed into Receive queue, read packets from Receive Queue and supply payload data to the application. Additional details of an example packet header match logic circuit 516 will be understood from the above explanation of FIG. 2.

In operation, the user application 508 can receive user-provided high-level configuration information at input 522 to define network packet match rules used by the header match logic circuit 516 to match packet headers to action programs. Defining a match rule includes specifying packet header stack, referred to as “the rule” to be matched with an action to be performed using an action program in response to receiving a packet with packet header stack that matches the rule. For example, an illustrative match rule and an associated high-level action can be defined as indicated in Table 4. The LAN driver 512 is used to configure the host computer system 502 to configure the header logic match circuit 516 based upon the user-defined match rules.

TABLE 4

| Match Rule | Action |
|---|---|
| Src IPv4 = 10.0.0.10, Dst IPv4 = 10.0.0.20, | Add VLAN header |
| Protocol = TCP | with tag type = 0x20 |

It will be appreciated that although only one match rule and one associated action are shown in Table 4, a user may specify multiple match rules and corresponding actions. Moreover, different sets of match rules may be specified for different packet flows.

The compiler program 514 is used to configure the host system 502 to translate a high-level application program (e.g., Linux or DPDK) 508 that specifies one or more actions to an action program that can be stored at memory 106 and that includes a set of instructions that can be used to configure the packet processor logic circuit 518 to perform one or more packet header level micro-operations (e.g., shift and/or modify) on packet headers.

In operation, header match logic 516 associates a header stack of an input packet received over network 109 at line 524 that matches a rule, with an action program, one of 118₁-118ₖ, stored in memory 106 that corresponds to the rule. Assuming, for example, that the header match logic 516 determines that a received packet matches the rule indicated in Table 4, the packet header is transmitted to the packet processor logic circuit 518, and an action program that includes a set of instructions to execute on the packet processor logic circuit 518 to perform the action described in Table 4 is retrieved from memory 106 and loaded to cache memory 520, which in this case involves inserting a VLAN header using an “INSERT” MISA instruction. The packet is then placed into a receive queue created by LAN driver 512. Later the LAN driver 512 reads the packet and sends it to networking stack 510. As the packet header is already processed by packet processor logic circuit 518, in this case inserting VLAN, networking stack 510 can send the packet directly to user application 508, saving significant software processing time.

The packet header processing circuit 504 may be required to handle many connections or communication flows. A packet flow, for example, may comprise a continuous stream of packets transmitted over network 109 between network-connected devices and typically is identified at least in part by a combination of source and destination addresses, source and destination ports, and protocol headers. Since packet header structures can be different in different packet flows, correspondingly different match and action rules may be required for the packets of the different flows. Accordingly, the LAN driver 512 can be used to send different configuration information on line 523 to configure the match circuit 516 to be able to handle different packet flows, and the compiler 514 can be used to compile different action programs to handle different flows. As explained below, an example packet header processor logic circuit 518 includes multiple packet processor circuit cores that can be configured to operate in parallel to simultaneously support multiple different packet flows.

FIG. 7 is an illustrative block diagram showing additional details of an example packet header processor logic circuit 518 and associated cache memory 520 in accordance with some embodiments. Packet header processor 518 includes multiple micro-instruction architecture (MISA) packet header processor cores 6021 to 602, coupled to operate in parallel. A subset of the action programs 118₁-118ₖ (e.g., those currently in use) can be copied to local (e.g., on-chip) cache memory 520. The dashed lines 601 indicate the transmission of action programs from the host memory 106 for temporary storage in the cache memory 520. The network packet processing circuit 504 can use multiple packet header processor cores 6021 to 602n, configured using different cached action programs to operate in parallel to simultaneously process multiple network packet flows.

An example packet processor 518 includes header routing logic 604 to route packet header stacks and corresponding packet header arrangement information (e.g., PTID and offset information) for different packets to different packet processor cores 6021 to 602, and includes instruction set routing logic 606 that can route different action program instruction sets to different packet processor cores 6021 to 602n. Control logic 608 can control the routing of packet headers, arrangement information, and action program instruction sets to packet processor cores 6021 to 602n.

It will be appreciated that different sets of match rules may be specified for different packet flows and that different match rules may cause different action programs to be accessed at persistent memory 106 and transmitted to cache memory 520. For example, an action program 1182 may be cached to configure packet processor core 6021 to process a packet based upon match rules for a first packet flow; an action program 1186 may be cached to configure packet processor core 6022 to process a packet based upon match rules for a second packet flow; an action program 1185 may be cached to configure packet processor core 6023 to process a packet based upon match rules for a third packet flow; action program 1189 may be cached to configure packet processor core 6024 to process a packet based upon match rules for a fourth packet flow; and an action program 1184 may be cached to configure packet processor core 6025 to process a packet based upon match rules for a fifth packet flow. Thus, different cores 6021 to 602n can be used in parallel to process different packet flows that are subject to different match rules and the number of packet processor cores operating in parallel can scale with network traffic demand.

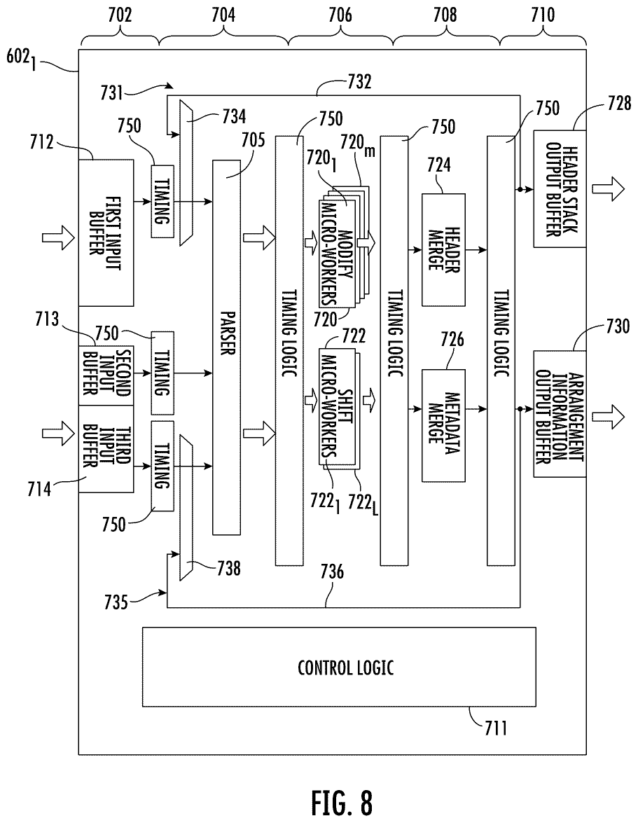

FIG. 8 is an illustrative block diagram showing details of an example packet header processor core 6021 in accordance with some embodiments. The example packet header processor core 6021 includes multiple logic circuit stages that operate in sequence. The packet processor core includes timing logic (e.g., registers) 750 to manage the sequencing of functions performed at the different sequential stages. The example packet header processor core 6021 includes an input stage 702, a parser stage 704, a micro-operations stage 706, a merger stage 708, and an output stage 710. The packet header processor core 6021 includes control logic 711 to control the stages and to inform controller 608 of status, e.g., idle or working.

Input stage 702 includes first input buffer logic 712 to input a header stack portion (input header assembler block) of a received packet, second input buffer logic 713 to input action program instructions that are matched to the received header stack, and third input buffer logic 714 to input header arrangement information that corresponds to the received header stack. The respective first, second, and third input buffer logic circuits 712, 713, and 714 can include one or more register circuits to temporarily store a respective header stack, instruction set, and arrangement information. The arrangement information can include an action program page, metadata, and packet arrangement information (e.g., PTID and offset information).

Parser stage 704 includes parser logic 705 that can parse header_id fields in a received action program page to identify header types to be adjusted within a received packet. The parser stage 704 can use the PTID and offset information as a guide to parse a received packet header stack to identify header types and their locations within the header stack. The parser logic 705 associates individual headers within a header stack with action program instructions used to process the headers and to align header offsets within the header stacks with field offsets within adjustment instructions.

The micro-operation stage 706 includes logic to execute instructions of a received action program page in parallel to simultaneously execute the instructions of the action program. The micro-operation stage 706 includes a modify micro-operation logic (M_{W}) logic block 720 and a shift micro-operation logic (S_{W}) logic block 722.

The modify micro-operation logic block 720 can be configured to determine tasks required to modify individual headers within a header stack based on individual instructions in a received action program page targeting the headers. Example modifications include replacing a portion of the content within a header (e.g., one or more bytes within a field of the header) with different content, adding additional content to a header, and removing content from a header. Moreover, example modifications can include adding or deleting an entire header (e.g., adding a VXLAN tunnel layer-known as encapsulation. The micro-operation logic blocks 720 and 722 includes multiple modify micro-worker (M_{MW}) logic units 720₁ to 720ₘ and multiple modify micro-workers 7221 to 722L that can be used to execute modifications to different header portions (e.g., fields within a header) based upon action program instructions targeted to the header. It is noted that some action program pages utilize a larger number of the M_{MW} logic units 720₁ to 720ₘ. Thus, the number of M_{MW} logic units used is scalable based on the needs of an action program page.

The shift micro-operation logic block 722 includes multiple modify micro-worker (S_{MW}) logic units 7221 to 722L that can be used to determine shift tasks required to adjust the location and/or length of headers or fields within a header or within a header stack, e.g., to adjust space in a header stack in view of the addition and/or deletion of a header or to adjust the length of a field within a header in view of the addition and/or deletion of information to/from the header.

Merger stage 708 includes header merger logic 724 and metadata merger logic 726. Individual M_{MW} logic units 720₁ to 720ₘ operate on separate copies of the header stack to determine modifications to their respective copies e.g., to determine information to add to, delete from, or replace in one or more headers or header fields. In an example packet header processor core 6021, header merger logic 724 combines the results of shift and modify operations determined using the M_{W} and S_{W} logic blocks 720, 722. The metadata merger logic 726 modifies the arrangement information (e.g., PTID and offset information), based on the modifications and/or shifts to the headers and/or header fields within the header stack determined using the Mw and S_{W} logic blocks 720, 722. For example, action program instructions can include information that indicates header types to be added, header types to be deleted, and shifts that affect header offsets from the payload.

The output stage 710 includes a header stack output buffer 728 and a metadata output buffer. The header stack output buffer 728 receives a modified header stack that is modified based on the action program page currently received (i.e., the most recently received page) at the input stage 702. The metadata output buffer receives arrangement information (e.g., PTID and offset) modified based on modifications to the received header stack. More particularly, the arrangement information received at buffer 730 indicates PTID and offset information for the modified header stack received at buffer 728.

The packet processor core 6021 includes a header stack feedback circuitry 731 that includes feedback path 732 and header multiplex selector 734. The packet processor core 6021 also includes an arrangement information feedback circuitry 735 that includes feedback path 736 with arrangement information multiplex selector 738. As explained above, an action program can include more than one page, e.g. page_0 and page_1. The first page of an action program (e.g., page_0) can include instructions used to configure the example packet processor core 6021 to impart actions on an original header stack of packet received over the network 109. Corresponding header arrangement information (e.g., PTID and offset information) received at the packet processor core 6021 with the first page (e.g., page_0) can be used to locate headers within the original header stack of a packet received at input stage 702. A subsequently received page of a multi-page action program (e.g., page_1) includes instructions used to configure the example packet processor worker 6021 to impart actions to a modified version of the packet header recirculated to the parser stage 704 via the header stack feedback path 732. Corresponding arrangement information (e.g., PTID and offset information) fed back to the parser stage 702 via the arrangement control information feedback path 736 can be used to locate headers within the modified header stack recirculated to the parser 704 via the header stack feedback path 732. The header stack feedback path 732 recirculates an updated header stack to the header multiplex selector 734, which selects between a header stack received at the input stage 702 and an updated version of the header stack fed back on feedback path 732 from the merger stage 708 and provides the selected version to the parser logic 705. The arrangement control information feedback path 736 recirculates updated control information to the arrangement control multiplex selector 738, which selects between an original version of the arrangement control information received at the input stage 702 and an updated version of the control information fed back on feedback path 736 from the arrangement control updated logic 726 and provides the selected version to the parser logic 705.

Control logic 711 can be configured to control selectors 734, 738. For example, a page_link instruction in a first page (e.g., page_0) of an action program can indicate a memory location of a second page (e.g., page_1) of an action program. The control logic 711 can control selections by the header multiplex selector 734 and by the arrangement control multiplex selector 738 based upon whether a received action program includes a page_link instruction. Moreover, the control logic 711 can include memory access logic circuitry 755 to cause memory 106/520 to send a next action program page (e.g., page_1) to the first input buffer logic 712 based upon a memory location specified in a page_link instruction.

Thus, arrangement information that is first determined using packet parser 102 can be modified in the course of each operational iteration of the packet header processor core 6021 operations to keep the arrangement information current relative to modifications imparted to the header stack by the modify micro-operation logic block 720 and the shift micro-operation logic block 722. As a result, the parser logic 705 can use recirculated modified arrangement information to locate header types within corresponding recirculated modified versions of the header stack. Therefore, there is no need to reparse the header stack to identify and locate headers within a modified header stack before performing additional actions on the modified header stack.

The above description is presented to enable any person skilled in the art to create and use action microinstruction architecture processor circuit. Various modifications to the embodiments will be readily apparent to those skilled in the art, and the generic principles defined herein may be applied to other embodiments and applications without departing from the spirit and scope of the invention. In the preceding description, numerous details are set forth for the purpose of explanation. However, one of ordinary skill in the art will realize that the embodiments in the disclosure may be practiced without the use of these specific details. In other instances, well-known processes are shown in block diagram form so as not to obscure significant aspects of the disclosure with unnecessary detail. Identical reference numerals may represent different views of the same or similar item in different drawings. Thus, the foregoing description and drawings of examples in accordance with the present invention are merely illustrative of the principles of the invention. Therefore, it will be understood that various modifications can be made to the embodiments by those skilled in the art without departing from the spirit and scope of the invention, which is defined in the appended claims.

1. A method to process a network packet comprising:
storing a first set of instructions in a non-transitory storage medium that includes one or more respective header adjustment instructions that include a header type identifier, operation code, and operand;
receiving the first set of instructions at a packet header processor;
receiving a header stack at the packet header processor; and
configuring a packet processor circuit with the first set of instructions to,
adjust in parallel, headers in the header stack that are identified by a header identifier within an adjustment instruction in the first set of instructions to produce a first modified header stack, based on, for each such identified header, a respective opcode and a respective operand included in a respective header adjustment instruction in the first set of instructions that includes a respective header identifier that identifies such identified header.

2. The method of claim 1,
wherein adjusting each header in the header stack that is identified by a header identifier within an adjustment instruction in the first set of instructions includes adjusting, for each such identified header, by performing at least one of adding information to a field within the header, deleting information from a field within the header, or shifting at least a portion of the information within such identified header.

3. The method of claim 1,
wherein adjusting each header in the header stack that is identified by a header identifier within an adjustment instruction in the first set of instructions includes adjusting by adding information to or deleting information from a field within at least one identified header; and
wherein simultaneous adjusting each header in the header stack that is identified by a header identifier within an adjustment instruction in the first set of instructions includes adjusting by shifting at least a portion of the information within at least one identified header.

4. The method of claim 1 further including:
producing a copy of the header stack for each adjust operation performed on the header stack;
wherein adjusting each header in the header stack that is identified by a header identifier within an adjustment instruction in the first set of instructions includes adjusting a first copy of the header stack by adding information to or deleting information from a field within at least one identified header in the first copy of the header stack;
wherein adjusting each header in the header stack that is identified by a header identifier within an adjustment instruction in the first set of instructions includes adjusting a second copy of the header by shifting at least a portion of the information within at least one identified header in the second copy of the header stack; and further including:
merging adjusted header information from the first copy of the header stack with adjusted header information from the second copy of the header stack to produce at least a portion of the first modified header stack.

5. The method of claim 1,
wherein the instructions are stateless.

6. The method of claim 1,
using a general-purpose processor configured with a compiler program to convert multiple different high-level computer program instructions defining different network packet processing actions to the first set of instructions; and
storing the first set of instructions in a non-transitory storage medium.

7. The method of claim 1 further including:
receiving arrangement information at the packet header processor that indicates locations of header types within the header stack; and
using the received arrangement information to associate received adjustment instructions with header types in the received header stack based on respective header identifiers within the received adjustment instructions of the first set of instructions.

8. The method of claim 7 further including:
parsing the header stack to identify header types within the header stack, identify offsets of the identified header types from a packet payload, and produce arrangement information that indicates locations of header types within the header stack.

9. The method of claim 1 further including:
receiving arrangement information at the packet header processor that indicates locations of header types within the received header stack; and
parsing the received first set of instructions, the received header stack, and the received arrangement information to associate received adjustment instructions with header types in the received header stack.

10. The method of claim 1 further including:
using a general-purpose processor to convert one or more high-level computer program instructions defining one or more network packet processing actions to the first set of instructions for configuring the packet header processor circuit to perform the one or more packet processing actions.

11. The method of claim 1 further including:
wherein storing a first set of instructions in a non-transitory storage medium storing the first set of instructions contained in a page format with a predetermined fixed number of instructions that have an identical predetermined fixed number of bits; and
wherein receiving the first set of instructions to the packet header processor includes receiving the instructions of an entire first page in parallel to the packet header processor.

12. The method of claim 1,
wherein the one or more respective header adjustment instructions have identical field layouts for header type identifiers, operation codes, and operands.

13. A method to process a network packet comprising:
storing a first set of executable instructions, wherein each set of instructions includes multiple respective header adjustment instructions that include a header type identifier, operation code, and operand;
receiving the first set of instructions at a packet header processor;
receiving a header stack at the packet header processor;
receiving arrangement information at the packet header processor that indicates locations of header types within the header stack;
using the received arrangement information to associate received adjustment instructions in the first set of instructions with header types in the received header stack based on respective header identifiers within the received adjustment instructions in the first set of instructions;
configuring the packet processor circuit with the first set of instructions to,
adjust in parallel, headers in the header stack that are identified by a header identifier within an adjustment instruction in the first set of instructions to produce a first modified header stack based on, for each such identified header, a respective opcode and a respective operand included in a respective header adjustment instruction in the first set of instructions that includes the respective header identifier that identifies such identified header;
producing modified arrangement information that indicates locations of header types within the first modified header stack;
receiving a second set of instructions at the packet header processor;
receiving the first modified header stack as feedback input at the packet header processor;
receiving the modified arrangement information as feedback input at the packet header processor that indicates locations of header types within the first modified header stack;
using the received modified arrangement information to associate received adjustment instructions in the second set of instructions with header types in the received modified header stack based on respective header identifiers within the received adjustment instructions in the second set of instructions; and
configuring a packet processor circuit with the second set of instructions to,
adjust in parallel, headers in the modified header stack that are identified by a header identifier within a adjustment instruction in the second set of instructions to produce a second modified header stack, based on, for each such identified header, a respective opcode and a respective operand included in a respective header adjustment instruction in the second set of instructions that includes the respective header identifier that identifies such identified header.

14. The method of claim 13 further including:
storing the first set of executable instructions and the second set of executable instructions in a non-transitory storage medium, the first of instructions contained in a first page and the second set of instructions contained in a second page, each of the first and second pages having identical predetermined fixed numbers of instructions that have identical predetermined fixed numbers of bits;
wherein receiving the first set of instructions at the packet header processor includes receiving the instructions of an entire first page in parallel to the packet header processor; and
wherein receiving the second set of instructions at the packet header processor includes receiving the instructions of the entire second page in parallel to the packet header processor;
wherein the first set of instructions include an instruction pointing to a memory address of the second set of instructions in the non-transitory storage medium.

15. The method of claim 14 further including:
using match logic to match the packet header stack to the first set of instructions stored in the non-transitory storage medium.

16. The method of claim 13 further including:
using a general-purpose processor to convert multiple high-level computer program instructions defining multiple network packet processing actions to the first set of executable instructions and the second set of executable instructions for configuring the packet header processor circuit to perform the one or more packet processing actions.

17. A network packet processing system comprising:
a packet header processor circuit including:
an instruction input to receive a set of instructions;
a packet header stack input to receive a packet header stack;
a packet header arrangement input to receive packet header arrangement information that indicates locations of header types within the received header stack;
a parser circuit to parse the received set of instructions, the received header stack, and the received arrangement information to associate the received adjustment instructions with header types in the received header stack;
a micro-operations processing circuit; and
a non-transitory storage medium storing multiple respective sets of executable instructions that include header adjustment instructions that include a header type identifier, operation code, and operand, each respective set of instructions, when executed by the packet header processor circuit, causes the micro-operations processing circuit to perform operations comprising:
adjusting in parallel, headers in the header stack that are identified by a header identifier within an adjustment instruction in a respective set of instructions currently received at the instruction input to produce a modified header stack, based on, for each such identified header, a respective opcode and a respective operand included in a respective header adjustment instruction in the respective set of instructions that includes the respective header identifier that identifies such identified header.

18. The network packet processing system of claim 17,
wherein the operations further including:
producing modified packet arrangement information that indicates locations of header types within the modified header stack;
wherein the packet header processor circuit further including:
feedback circuitry to controllably feed back the modified header stack to the parser circuit based on at least one instruction in the respective set of instructions currently received at the instruction input;
feedback circuitry to controllably feed back the modified packet arrangement information to the parser circuit based on the at least one instruction in the respective set of instructions currently received at the instruction input; and
memory control logic circuitry to cause access to a next set of instructions from the non-transitory storage medium to input to the instruction input based on the at least one instruction in the respective set of instructions currently received at the instruction input.

19. The network packet processing system of claim 17,
wherein the packet header processor circuit further including:
a modified packet header output to output the modified packet header stack.

20. The network packet processing system of claim 17 further including:
match logic to match a packet header stack to a set of instructions stored in the non-transitory storage medium.

21. The network packet processing system of claim 17,
wherein adjusting each header in the header stack that is identified by a header identifier within an adjustment instruction in the respective set of instructions currently received at the instruction input includes adjusting, for each such identified header, by performing at least one of adding information to a field within the header, deleting information from a field within the header, or shifting at least a portion of the information within such identified header.

22. The network packet processing system of claim 17,
wherein adjusting each header in the header stack that is identified by a header identifier within an adjustment instruction in the respective set of instructions currently received at the instruction input includes adjusting by adding information to or deleting information from a field within at least one identified header; and
wherein adjusting each header in the header stack that is identified by a header identifier within an adjustment instruction in the respective set of instructions currently received at the instruction input includes adjusting by shifting at least a portion of the information within at least one identified header.

23. The network packet processing system of claim 17, the operations further including:
producing a copy of the header stack for each adjust operation performed on the header stack;
wherein adjusting each header in the header stack that is identified by a header identifier within an adjustment instruction in the respective set of instructions currently received at the instruction input includes adjusting a first copy of the header stack by adding information to or deleting information from a field within at least one identified header in the first copy of the header stack;
wherein adjusting each header in the header stack that is identified by a header identifier within an adjustment instruction in the respective set of instructions currently received at the instruction input includes adjusting a second copy of the header by shifting at least a portion of the information within at least one identified header in the second copy of the header stack; the operations further including:
merging adjusted header information from the first copy of the header stack with adjusted header information from the second copy of the header stack to produce at least a portion of the modified header stack.

24. The network packet processing system of claim 17,
wherein the non-transitory storage medium stores the multiple respective sets of executable instructions in a page format with each page having a predetermined fixed number of instructions that have an identical predetermined fixed number of bits.

25. The network packet processing system of claim 17 further including:
a general-purpose processor configured with executable instructions to convert multiple high-level computer program instructions defining different network packet processing actions to the multiple respective sets of executable instructions stored in the non-transitory storage medium in a page format with a predetermined fixed number of instructions that have an identical predetermined fixed number of bits.

26. A network packet processing system comprising:
multiple packet header processor core circuits;
a non-transitory storage medium storing multiple respective sets of instructions that are executable by the respective packet header processor core circuit, wherein respective sets of instructions include one or more respective header adjustment instructions that include a header type identifier, operation code, and operand;
wherein each respective core circuit includes:
a respective instruction input to receive a respective set of instructions;
a respective packet header stack input to receive a respective packet header stack;
a respective packet header arrangement input to receive respective packet header arrangement information that indicates locations of header types within the inputted header stack;
a respective parser circuit to parse the received set of instructions, the received header stack, and the received arrangement information to associate the received adjustment instructions with header types in the received header stack; and
a respective micro-operations processing circuit configurable using a respective set of instructions from the non-transitory storage medium to cause the respective micro-operations processing circuit to perform operations including:
adjusting in parallel, headers in the respective header stack that are identified by a header identifier within an adjustment instruction in a respective set of instructions currently received at the respective instruction input to produce a respective modified header stack, based on, for each such identified header, a respective opcode and a respective operand included in a respective header adjustment instruction in the respective set of instructions that includes the respective header identifier that identifies such identified header; further including:
routing circuitry for routing different respective header stacks to different respective core circuits for routing different respective arrangement information to different respective core circuits and for routing circuitry for routing different respective sets of instructions to different respective core circuits.

27. The network packet processing system of claim 26,
wherein each respective set of instructions stored in the non-transitory storage medium is arranged in a page format with a predetermined fixed number of instructions that have an identical predetermined fixed number of bits, including respective header adjustment instructions that have identical field layouts for header type identifiers, operation codes, and operands.

28. The network packet processing system of claim 26,
wherein the operations further including:
producing respective modified packet arrangement information that indicates locations of header types within the respective modified header stack;
wherein each respective core circuit further including:
respective feedback circuitry to controllably feed back the respective modified header stack to the respective parser circuit based on at least one instruction in the respective set of instructions currently received at the respective instruction input;
respective feedback circuitry to controllably feed back the respective modified packet arrangement information to the respective parser circuit based on the at least one instruction in the respective set of instructions currently received at the respective instruction input; and
memory access logic circuitry to controllably access a next set of instructions from the non-transitory storage medium to input to the respective instruction input based on the at least one instruction in the respective set of instructions currently received at the respective instruction input.

29. The network packet processing system of claim 28,
wherein each respective set of instructions stored in the non-transitory storage medium is arranged in a page format with a predetermined fixed number of instructions that have an identical predetermined fixed number of bits, including respective header adjustment instructions that have identical field layouts for header type identifiers, operation codes, and operands.
